(19) United States
(12) Patent Application Publication
(10) Pub. No.: US 2014/0052641 A1
(43) Pub. Date: Feb. 20, 2014

(54) Electronic Invoice Issuing System For Electronic Commerce Website

(71) Applicant: Tsinghua University, Beijing (CN)

(72) Inventors: Yueting Chai, Beijing (CN); Hongyang Chu, Beijing (CN); Yi Liu, Beijing (CN)

(73) Assignee: Tsinghua University, Beijing (KR)

(21) Appl. No.: 13/969,866

(22) Filed: Aug. 19, 2013

(30) Foreign Application Priority Data
Aug. 20, 2012 (CN) 201210297894.6

(51) Int. Cl. G06Q 20/10

(52) U.S. Cl. CPC G06Q 20/102
USPC 705/71; 705/37

(57) ABSTRACT

An electronic invoice issuing system for an electronic commerce website is provided. The system comprises: an online trading platform; a security electronic invoice apparatus, preset with a code table of goods and services, an electronic invoice template and a digital signature of an electronic commerce enterprise, and configured to receive a payer information and a trading information from the online trading platform, to add the payer information and the trading information into the electronic invoice template according to the code table of goods and services so as to issue an electronic invoice, and to digitally sign the electronic invoice by the digital certificate of the electronic commerce enterprise; and an electronic invoice information management platform with an access interface, configured to receive the electronic invoice from the security electronic invoice apparatus, to store a registration of the electronic invoice and to provide the electronic invoice to a predesignated user.

### CROSS-REFERENCE TO RELATED APPLICATION

This application claims priority to and benefits of Chinese Patent Application Serial No. 201210297894.6, filed with the State Intellectual Property Office of P. R. China on Aug. 20, 2012, the entire content of which is incorporated herein by reference.

### FIELD

Embodiments of the present disclosure generally relate to a technical field of electronic commerce, and more particularly to an electronic invoice issuing system for an electronic commerce website.

### BACKGROUND

A number of order forms of various electronic commerce enterprises (shopping website, trading platform, etc) increases fast along with a development of an electronic commerce. However, a cost of traditional paper invoices increases rapidly and a management of the paper invoices is inefficient because the management of traditional paper invoices is complex and cannot meet with characteristics of the electronic commerce such as paperless and speedy, which is one of bottlenecks restricting the development of the electronic commerce.

Problems such as fake invoices exist in the traditional paper invoices and invoice management process. During the process of issuing traditional invoices, the consumer doesn't ask for the invoice sometimes on their own initiative, resulting in that the payee may not issue invoice or refuse to issue invoice with some reasons, and the payer usually doesn't ask for the invoice according to an actual trading amount, and all of these bring a mass of tax loss.

A cost of tax collecting and inspecting is very high, which adds a lot of burden. Aiming at the problems appearing in some invoices and trading, the tax departments need to check all the invoices and account books of related enterprises, which cost more financial and material resources when the trading performs in different places. Trading partners in the electronic commerce trading are usually in different places or even in different countries, and therefore, the tax management system based on the paper invoices is facing a big challenge.

In addition, the paper invoices waste a lot of resources every year and don't meet with the requirement of energy conservation and carbon emissions reduction.

### SUMMARY

Embodiments of the present disclosure seek to solve at least one of the problems existing in the prior art to at least some extent.

Therefore, the aim of the present disclosure is to provide an electronic invoice issuing system for an electronic commerce website, which may solve the problems such as fake invoices, no issuing invoices and falsely issuing invoices efficiently and reduce the tax loss, meanwhile the entire process is performed paperless. In addition, the electronic invoice issuing system has advantages of speediness and energy conversation.

To this end, according to an embodiment of the present disclosure, an electronic invoice issuing system for an electronic commerce website is provided. The electronic invoice issuing system comprises: an online trading platform, configured to provide a payer information and a trading information; a security electronic invoice apparatus, preset with a code table of goods and services, an electronic invoice template and a digital certificate of an electronic commerce enterprise, and configured to receive the payer information and the trading information from the online trading platform, to add the payer information and the trading information into the electronic invoice template according to the code table of goods and services so as to issue an electronic invoice, and to digitally sign the electronic invoice by the digital certificate of the electronic commerce enterprise; and an electronic invoice information management platform with an access interface, configured to receive the electronic invoice from the security electronic invoice apparatus, to store a registration of the electronic invoice and to provide the electronic invoice to a predesignated user.

According to the electronic invoice issuing system for an electronic commerce website of the present disclosure, by using the trading information and the payer information on the online trading platform, the electronic invoice is generated automatically to exist as a digital data, and the electronic invoice may be transmitted to the electronic invoice information management platform to file a registration of the electronic invoice. Therefore, the entire process of invoice generation and management is realized paperless, the efficiency of the businesses related to the invoices is improved and the inconvenience of generating and managing paper invoices is avoided. In addition, by digitally signing the electronic invoice with the digital signature of the tax department and the digital signature of the electronic commerce enterprise, an authenticity, a legality and an efficiency of the electronic invoice are ensured, and the tax loss is reduced. Furthermore, the application of the electronic invoice does not only meet with the development trend of the electronic commerce, but also reduces the consumption of the material resources. Therefore, the electronic invoice issuing system according to the present disclosure has advantages of energy conversation, consumption reduction and emissions reduction.

In addition, the electronic invoice issuing system for the electronic commerce website according to embodiments of the present disclosure may also be provided with the following additional technical features:

In some embodiments, the electronic invoice template comprises a predetermined digital signature.

In some embodiments, the security electronic invoice apparatus is further configured to encrypt the electronic invoice and to transmit the encrypted electronic invoice to the electronic invoice information management platform.

In some embodiments, the security electronic invoice apparatus is preset with a public key of the electronic invoice information management platform, the electronic invoice is encrypted by the public key, and the electronic invoice information management platform decrypts the encrypted electronic invoice by a private key.

In some embodiments, the security electronic invoice apparatus comprises: an electronic invoice generation module, configured to receive the payer information and the trading information from the online trading platform and to issue the electronic invoice by adding the payer information and the trading information into the electronic invoice template; an electronic invoice transmit module, configured to transmit the electronic invoice to the online trading platform so that the payer obtains the electronic invoice from the online trading platform; an electronic invoice query module, configured to query the electronic invoice according to a query information input by the predesignated user; an electronic invoice reporting module, configured to report a summarized information of the electronic invoice according to the query information input by the predesignated user; and a tax rate maintaining module, configured to classify the products according to industries, tax categories and tax rates and to maintain a tax rate of the products.

In some embodiments, the security electronic invoice apparatus further comprises: an electronic invoice template verification module, configured to verify the electronic invoice template according to the digital certificate of the electronic commerce enterprise and the predetermined digital signature.

Furthermore, the electronic invoice issuing system also comprises: an electronic invoice download platform, authenticated by the tax department, and configured to update the electronic invoice template when the electronic invoice template is verified to be invalid.

In some embodiments, the payer information comprises any one of a payer name, a payer identification and a payer contact information, and the trading information comprises any one of a trading account, a trading amount and a product information.

In some embodiments, the predesignated user comprises any one of the payer, the electronic commerce enterprise and a tax department.

In some embodiments, the electronic invoice issuing system comprises a plurality of security electronic invoice apparatuses.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a block diagram of an electronic invoice issuing system for an electronic commerce website according to an embodiment of the present disclosure;

FIG. 2 is a block diagram of a security electronic invoice apparatus of the electronic invoice issuing system according to an embodiment of the present disclosure; and

FIG. 3 is a flow chart of generating an electronic invoice according to the electronic invoice issuing system for the electronic commerce website of the present disclosure.

### DETAILED DESCRIPTION

Reference will be made in detail to embodiments of the present disclosure, and the embodiments are described herein with reference to drawings. The embodiments shall not be construed to limit the present disclosure, though the present disclosure is described. Contrarily, the present disclosure includes substitution, amendment and equation in the spirit and scope of the right request added above. In order to make the theme of the present disclosure understood generally, a plurality of idiographic detail is clarified. However, it would be appreciated by those skilled in the art that the embodiments of the present disclosure may not adopt the idiographic detail. In other case, there is no detailed description about the methods, procedure, parts and circuit known to all, as a result that the unnecessary mistiness about the embodiments of the present disclosure is avoided.

Though the diversified elements are described with the nomenclature the first, the second and so on in the article, these elements shall not be limited by the nomenclature. The nomenclature is only used to distinguish from the first element and the second element. For example, the first sort criteria may be named the second sort criteria, similarly, the second sort criteria may be named the first sort criteria on the condition that it is not out of the scope of the present invention. Both the first sort criteria and the second sort criteria are the sort criteria, but they are different from each other.

The adoption of the nomenclature in the description of the present invention in the article is only to describe the particular embodiments, and the embodiments shall not be construed to limit the present disclosure. The singular form “one” and “said”, used in the description in the present invention and the right request, also means including plurality form, unless it is pointed out definitely in the article. It is also construed that the nomenclature “and/or” used in the article means and includes a compounding or all possible compounding made up of one or some related item listed. It is further construed that the nomenclature “comprise” and/or “include” specify the existence of the characteristic, operation, elements and parts, when they are used in the specification, but the existence and the addition of one or some other characteristic, operation, elements and parts or their team are not excluded.

The nomenclature “if” adopted in the article may be construed to means “when” or “at the time of . . . ” or “in answer to confirmation” or “according to the confirmation of . . . ” or “in answer to examination”, and the precondition stated is true. Similarly, according to the article, the phrase “if ensure [the precondition stated is true]”or “if [the precondition stated is true]” or “when [the precondition stated is true]” may be construed to mean “when confirm . . . ” or “in answer to confirmation” or “according to the confirmation of . . . ” or “when examine . . . ” or “correspond to examination”, and the precondition stated is true.

In the following, the electronic invoice issuing system for the electronic commerce website according to embodiments of the present disclosure will be described in detail with reference to the accompanying drawings.

FIG. 1 is a block diagram of an electronic invoice issuing system for an electronic commerce website according to an embodiment of the present disclosure. Referring to FIG. 1, the electronic invoice issuing system 100 comprises an online trading platform 110, a security electronic invoice apparatus 120 and an electronic invoice information management platform 130.

When trading partners (for example, a payer and an electronic commerce enterprise) on the electronic commerce website perform a trading by the online trading platform 110 of the electronic commerce website, the security electronic invoice apparatus 120 connects with the online trading platform 110, and the online trading platform 110 transmits the payer information (i.e., the information of the electronic commerce consumer and the trading information) to the security electronic invoice apparatus 120 when the electronic commerce trading happens, and then the security electronic invoice apparatus 120 issues an electronic invoice and transmits the electronic invoice to the electronic invoice information management platform 130 to store a registration of the electronic invoice so as to manage the electronic invoices uniformly. Therefore, the electronic commerce enterprise, the electronic commerce consumer and the tax department may query the information of the electronic invoice by the electronic invoice information management platform 130 to obtain the services related to the taxes.

Further, the security electronic invoice apparatus 120 is preset with a code table of goods and services, an electronic invoice template and a digital signature of the electronic commerce enterprise. The code table of goods and services includes product codes, product names, industry categories, tax categories and tax rates. The electronic invoice template comprises a predetermined digital signature (for example, a digital signature of the tax department) to make the electronic invoice template effective. In addition, the electronic invoice template may also comprise the name of the invoice, the information of the electronic commerce enterprise and the information of the invoice. When the trading happens on the online trading platform 110, the security electronic invoice apparatus 120 receives the payer information and the trading information (for example, the payer information includes but is not limited to the payer name, the payer identification and the payer contact information, the trading information includes but is not limited to the trading account (the payment account of the electronic commerce enterprise), the trading amount and the product information) from the online trading platform 110 such that the security electronic invoice apparatus 120 can add the trading information and the payer information into the electronic invoice template according to the code table of goods and services to issue the corresponding electronic invoice. For example, when the security electronic invoice apparatus 120 receives the product information (the product name and so on) in the trading, the security electronic invoice apparatus 120 looks up the product code corresponding to the product information in the code table of goods and services, obtains other information corresponding to the product code from the code table of goods and services according to the product code, and then selectively adds the above obtained information into the electronic invoice template according to the type of the electronic invoice template to issue the electronic invoice. At last, the electronic invoice is digitally signed by the digital certificate of the electronic commerce enterprise to make the electronic invoice effective.

The electronic invoice information management platform 130 is configured to obtain the electronic invoice from the security electronic invoice apparatus 120 to store a registration of the electronic invoice. In addition, the electronic invoice information management platform 130 has an access interface (not shown in the drawings) so as to provide the registration information of the electronic invoice to a predesignated user. In an embodiment of the present invention, the predesignated user includes but is not limited to the payer trading via the online trading platform 110, the electronic commerce enterprise and the tax department. In detail, with the access interface of the electronic invoice information management platform 130, it is possible to offer services to the electronic commerce enterprise, the electronic commerce consumer (the payer) and the tax department. For example, the electronic commerce enterprise may query the electronic invoice, obtain a summarized information of the electronic invoice and maintain the information of the electronic commerce enterprise via the electronic invoice information management platform 130, in addition, the electronic commerce consumer may query the electronic invoice and obtain the summarized information of the electronic invoice via the electronic invoice information management platform 130, and the tax department may query the electronic invoice, obtain the summarized information of the electronic invoice and query the information of the electronic commerce enterprise via the electronic invoice information management platform 130. Furthermore, the predesignated user may connect with the access interface via the Ethernet to make it convenient for the tax department, the electronic commerce enterprise and the electronic commerce consumer to query, count and download the electronic invoice online, meanwhile it is convenient for the tax department to check the tax information of the electronic commerce enterprise online by querying and counting the electronic invoice, thus realizing an online supervision of the electronic commerce enterprise.

According to the electronic invoice issuing system for the electronic commerce website of the present disclosure, by using the trading information and the payer information on the online trading platform of the electronic commerce website of the electronic commerce enterprise, the electronic invoice existing as an electronic data is generated automatically and the electronic invoice is transmitted to the electronic invoice information management platform to file a registration of the electronic invoice for management. Therefore, the entire process of the electronic invoice generation and management is realized paperless, the efficiency of the businesses related to the invoice is improved and the inconvenience of generating and managing paper invoices is avoided. In addition, by automatically signing the electronic invoice with the digital signature of the tax department and the digital signature of the electronic commerce enterprise, the authenticity, the legality and the efficiency of the electronic invoice are ensured, and the tax loss is reduced. In addition, the application of the electronic invoice does not only meet with the development trend of the electronic commerce, but also reduces the consumption of the material resources. Therefore, the electronic invoice has advantages of energy conversation, consumption reduction and emissions reduction.

It should be understood that, in order to avoid blowing the gaff when the security electronic invoice apparatus 120 transmits the electronic invoice to the electronic invoice information management platform 130 through the internet, and in order to improve the security of the transmission, the electronic invoice may be transmitted in an encryption form. In one embodiment of the present disclosure, the security electronic invoice apparatus 120 transmits an encrypted electronic invoice to the electronic invoice information management platform 130 after encrypting the electronic invoice. For example, the electronic invoice is transmitted and decrypted by a public key and a private key. Specifically, the security electronic invoice apparatus 120 is preset with a public key of the electronic invoice information management platform 130, the security electronic invoice apparatus 120 encrypts the electronic invoice with the public key and transmits the encrypted electronic invoice to the electronic invoice information management platform 130, and the electronic invoice information management platform 130 decrypts the encrypted electronic invoice with a private key and then stores the registration of the electronic invoice.

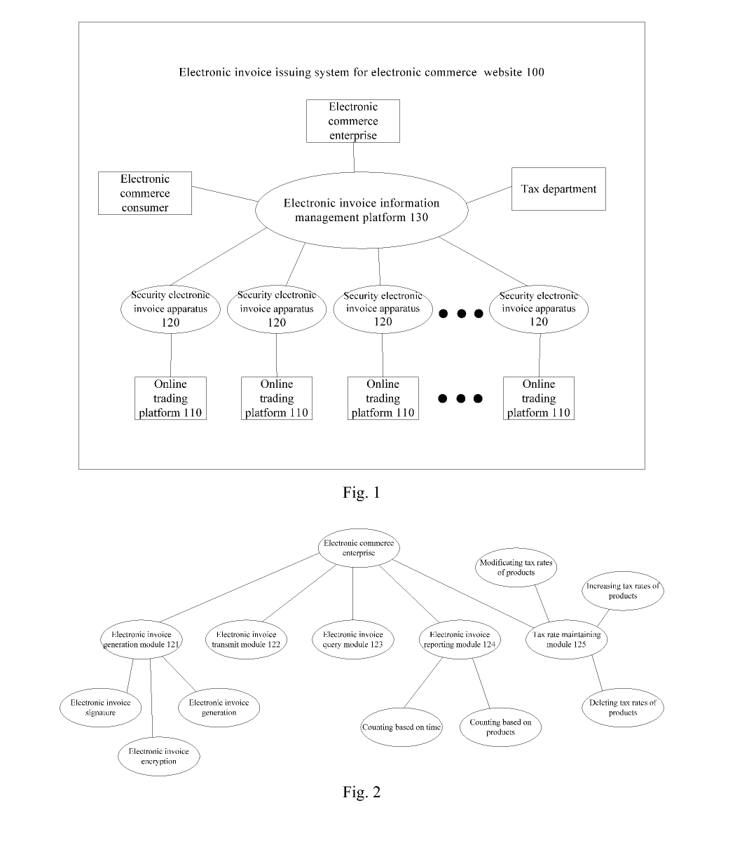

FIG. 2 is a block diagram of the security electronic invoice apparatus 120 according to an embodiment of the present disclosure. As shown in FIG. 2, the security electronic invoice apparatus 120 comprises an electronic invoice generation module 121, an electronic invoice transmit module 122, an electronic invoice query module 123, an electronic invoice reporting module 124 and a tax rate maintaining module 125.

The electronic invoice generation module 121 obtains the payer information and the trading information from the online trading platform 110 and issues the electronic invoice by adding the payer information and the trading information into the electronic invoice template according to the code table of goods and services.

The electronic invoice transmit module 122 transmits the electronic invoice to the online trading platform 110 so that the payer gets the electronic invoice from the online trading platform 110. For example, the electronic invoice output module 122 transmits the electronic invoice to the predesignated user (for example, the payer) via the online trading platform 110 and offers the services of downloading and online printing, and so on.

The electronic invoice query module 123 queries the electronic invoice according to the query information input by the predesignated user. In one embodiment of the present disclosure, the query information includes but is not limited to the code of the electronic invoice, the name of the electronic invoice, the issuing date range of the electronic invoice and the name of the payer. When the query information is input by the predesignated user, the electronic invoice query module 123 may output and display the query information in a list form, for example, the items of the list may comprise the code of the electronic invoice, the name of the electronic invoice, the issuing date range of the electronic invoice, the name of the payer, the trading amount, the information of the tax amount, and so on. Certainly, the query information may also be shown to the user in a view form. The electronic invoice query module 123 may also offer the services of downloading and online printing, and so on.

The electronic invoice reporting module 124 reports a summarized information of the electronic invoice according to the query information input by the predesignated user. In some embodiments of the present disclosure, the query information includes but is not limited to the issuing date range of the electronic invoice, the name of the electronic invoice and the category of the products. As specific examples, if the electronic invoice is to be counted based on the issuing date, the query information input by the predesignated user comprises the issuing date range of the electronic invoice and the name of the electronic invoice, and the display information after counting (i.e., the query information and the summarized information) comprises the issuing date of the electronic invoices, the name of the electronic invoices, the summarized number of the electronic invoices and the summarized trading amount of the electronic invoices, and so on; if the electronic invoice is to be counted based on the products, the query information input by the predesignated user comprises the category of the products, the issuing date range of the electronic invoice, the name of the electronic invoice and so on, and the display information after counting comprises the category of the products, the issuing dates of the electronic invoices, the names of the electronic invoices, the summarized number of the electronic invoices, the summarized trading amount of the electronic invoices and so on.

The tax rate maintaining module 125 classifies the products according to industries, tax categories and tax rates and maintains a tax rate of the products. Specifically, the tax rate maintaining module 125 may output the product codes, the product names, the industry categories, the tax categories and the tax rates to the predesignated user in the list form. In addition, the maintenance includes an increase, a modification and a deletion of the tax rates of the products, and the information about the increase, the modification and the deletion of the tax rates of the products can be provided to the user.

In addition, the security electronic invoice apparatus 120 may also have a data transmission interface (not shown in the drawings) used to transmit data to the electronic invoice information management platform 130, so that the security electronic invoice apparatus 120 may transmit the electronic invoice to the electronic invoice information management platform 130 for storage and management via the data transmission interface. In one embodiment of the present disclosure, the electronic invoice information management platform 130 may be a server with the electronic invoice information management and service functions, or a public foundation service platform for storing the registrations of the electronic invoices and managing the electronic invoices centrally. The data transmission interface of the security electronic invoice apparatus 120 may be connected with the electronic invoice information management platform 130 via the Ethernet. The security electronic invoice apparatus 120 encrypts the electronic invoice and transmits the encrypted electronic invoice to the electronic invoice information management platform 130, and then the electronic invoice information management platform 130 stores the registration of the electronic invoice with respect to each trading.

Further, the security electronic invoice apparatus 120 may also comprise an electronic invoice template verification module (not shown in the drawings). The electronic invoice template verification module verifies the electronic invoice template according to the digital certificate of the electronic commerce enterprise and the digital signature (for example, the digital signature of the tax department), or verifies the electronic invoice template stored in the security electronic invoice apparatus 120 by comparing it with an electronic invoice template provided by an electronic invoice download platform. Accordingly, the electronic invoice issuing system 100 may comprise the electronic invoice download platform (not shown in the drawings). Certainly, the electronic invoice download platform is authenticated by the tax department to ensure the legality and limitation of the electronic invoice download platform, and also to ensure the regularity, efficiency and legality of the electronic invoice template provided by the electronic invoice download platform. Specifically, when the electronic invoice template is verified to be invalid by the electronic invoice template verification module, for example, when the electronic invoice template stored in the security electronic invoice apparatus 120 is inconsistent with the electronic invoice template provided by the electronic invoice download platform, the electronic invoice template stored in the security electronic invoice apparatus 120 will be updated to achieve the issuing of the electronic invoice.

It should be noted that, the electronic invoice template in the electronic invoice download platform may be maintained and updated by a specially assigned person according to the current regulation of the tax department, so as to make sure that the electronic invoice template in the electronic invoice download platform is legal and approved by the tax department.

Referring to FIG. 1 again, there may be a plurality of security electronic invoice apparatuses 120 in the electronic invoice issuing system 100 so as to offer services to a plurality of electronic commerce enterprises.

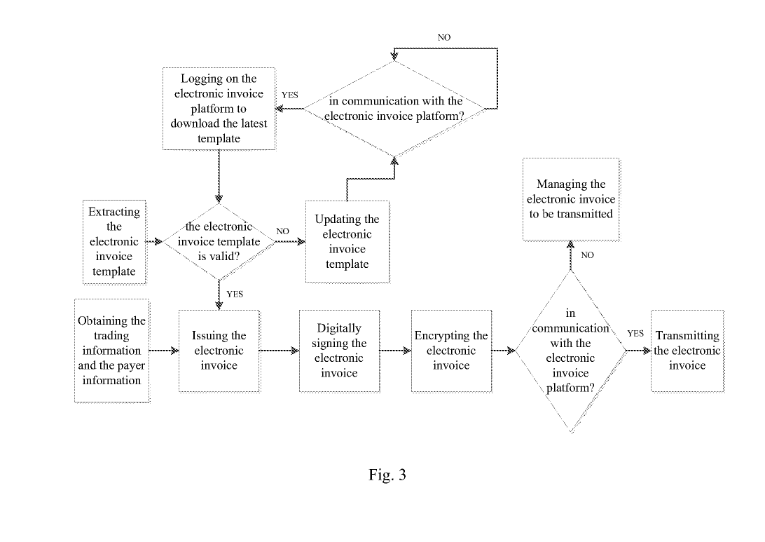

FIG. 3 is a flow chart of generating an electronic invoice according to the electronic invoice issuing system of the present disclosure, referring to FIGS. 1-3, the working process of the electronic invoice issuing system according to an embodiment of the present disclosure comprises the following steps. Firstly, when the online trading happens, the security electronic invoice apparatus 120 obtains the payer information and the trading information and extracts the electronic invoice template stored in local. Next, the security electronic invoice apparatus 120 verifies the electronic invoice template. Specifically, if the electronic invoice template stored in local is verified to be invalid, the electronic invoice platform (the electronic invoice download platform) is logged on automatically to download a latest and efficient electronic invoice template and the local electronic invoice template is updated with the latest electronic invoice template; if the electronic invoice template stored in local is verified to be valid, the trading information and the payer information are added into the electronic invoice template to achieve the issuing of the electronic invoice. Next, the security electronic invoice apparatus 120 digitally signs the electronic invoice with the digital certificate of the electronic commerce enterprise stored in local, and encrypts the electronic invoice with the digital certificate (the public key) of the electronic invoice information management and service platform (the electronic invoice information management platform 130). At last, the security electronic invoice apparatus 120 checks whether it is in communication with the electronic invoice information management and service platform, if yes, the electronic invoice is transmitted to the electronic invoice information management and service platform to store a registration of the electronic invoice, and if no, the electronic invoice is managed so as to be transmitted uniformly when the communication is available.

According to the embodiments of the present disclosure, the problems such as fake invoice, no issuing invoice and falsely issuing invoice are solved efficiently, the tax loss is reduced and the whole process is performed paperless. Therefore, the electronic invoice issuing system according to the present invention has advantages of speediness and energy conversation.

In the flow chart or any process or method description described with other manner may be construed to means including one or more modulate, segment and parts of the available code of the procedure of the process or for realizing a certain logical function, and the scope of the actualizing scheme selected preferentially of the present disclosure includes other actualization, and the function may be implemented with the basic coinstantaneous method or the contrary order, according to the related function, and the function may be not implemented as the order showed or discussed, which is understood by those skilled of the technical field of the embodiments of the present disclosure.

The logic and/or procedure described with other manner or showed in the flow chart, for example, may be considered to be the sequencer list for executing the instruction for realizing the logical function, concretely actualized in the readable medium in any computer to be used by the instruction execution system, device and equipment (such as the system based on the computer, the system including a processor and other system for fetching the instruction and executing the instruction from the instruction execution system, device and equipment), or used with the instruction execution system, device and equipment. As to the specification, “the readable medium in any computer” may be any device, and the device may include, store, communicate, diffuse or transmit procedure to be used by the instruction execution system, device and equipment or the device is used with the instruction execution system, device and equipment. The more concrete demonstration of the readable medium in any computer (the limited list) comprises: an electronic connection (an electronic device) with one or more wires, a portable computer box (a magnetism device), a random-access memory (RAM), a read-only memory (ROM), a erasable-programmable read-only memory (EPROM or flash memory), a optical fiber device and a portable compact disk read-only memory (CDROM). In addition, the readable medium of computer is even a paper or other appropriate medium to print the procedure on it, because the procedure obtained with electronic form may be edited, decrypted or dealt with other appropriate manner by optical scanning the paper or other medium, and then the procedure worked will be stored in the computer memory.

It is understood that each part of the present disclosure may be actualized by the hardware, software, firmware or their assembly. In the actualization manner, a plurality of procedure or manner may be actualized by the software or firmware, and the software or the firmware are stored in the memory and executed by the appropriate instruction execution system. For example, if the procedure or manner is actualized by the hardware, as the same as another actualization manner, the procedure or manner may be actualized by one of the following techniques of the field known to all or their assembly: a discrete logic circuit of the logic gate circuit for actualizing logic function to data signal, a special integrate circuit having an appropriate combination logic gate circuit, programmable gate array (PGA), field programmable gate array (FPGA) and so on.

All or parts of the procedure schlepped in the method for actualizing the embodiments of the present disclosure are understood by those common skilled of the technical field, which is achieved by the hardware dictated by the procedure. The procedure may be stored in a computer readable storage medium, and the procedure includes one of the procedures of the embodiments of the present disclosure or their assembly when it is actualized.

In addition, each function cell of the embodiments of the present disclosure may be integrated into a processing module, and these cells may physically exist respectively, and also two or plural of the cells are integrated into a processing module. The integrated module is not only actualized with the hardware, but also actualized with the software function module. When the integrated module is actualized with the software function module to be sold or used as an unattached production, the integrated module may be stored in a computer readable storage medium.

The storage medium mentioned above may be read-only memory, disk or CD.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

What is claimed is:

1. An electronic invoice issuing system for an electronic commerce website, comprising:
an online trading platform, configured to provide a payer information and a trading information;
a security electronic invoice apparatus, preset with a code table of goods and services, an electronic invoice template and a digital certificate of an electronic commerce enterprise, and configured to receive the payer information and the trading information from the online trading platform, to add the payer information and the trading information into the electronic invoice template according to the code table of goods and services so as to issue an electronic invoice, and to digitally sign the electronic invoice by the digital certificate of the electronic commerce enterprise; and
an electronic invoice information management platform with an access interface, configured to receive the electronic invoice from the security electronic invoice apparatus, to store a registration of the electronic invoice and to provide the electronic invoice to a predesignated user.

2. The electronic invoice issuing system according to claim 1, wherein the electronic invoice template comprises a predetermined digital signature.

3. The electronic invoice issuing system according to claim 1, wherein the security electronic invoice apparatus is further configured to encrypt the electronic invoice and to transmit an encrypted electronic invoice to the electronic invoice information management platform.

4. The electronic invoice issuing system according to claim 3, wherein the security electronic invoice apparatus is preset with a public key of the electronic invoice information management platform, the security electronic invoice apparatus encrypts the electronic invoice with the public key, and the electronic invoice information management platform decrypts the encrypted electronic invoice with a private key.

5. The electronic invoice issuing system according to claim 1, wherein the security electronic invoice apparatus comprises:
an electronic invoice generation module, configured to receive the payer information and the trading information from the online trading platform and to issue the electronic invoice by adding the payer information and the trading information into the electronic invoice template according to the code table of goods and services;
an electronic invoice transmit module, configured to transmit the electronic invoice to the online trading platform so that the payer obtains the electronic invoice from the online trading platform;
an electronic invoice query module, configured to query the electronic invoice according to a query information input by the predesignated user;
an electronic invoice reporting module, configured to report a summarized information of the electronic invoice according to the query information input by the predesignated user; and
a tax rate maintaining module, configured to classify products according to industries, tax categories and tax rates and to maintain a tax rate of the products.

6. The electronic invoice issuing system according to claim 5, wherein the security electronic invoice apparatus further comprises:
an electronic invoice template verification module, configured to verify the electronic invoice template according to the digital certificate of the electronic commerce enterprise and the predetermined digital signature.

7. The electronic invoice issuing system according to claim 6, further comprising:
an electronic invoice download platform, authenticated by the tax department, and configured to update the electronic invoice template when the electronic invoice template is verified to be invalid.

8. The electronic invoice issuing system according to claim 1, wherein the payer information comprises any one of a payer name, a payer identification and a payer contact information.

9. The electronic invoice issuing system according to claim 1, wherein the trading information comprises any one of a trading account, a trading amount and a product information.

10. The electronic invoice issuing system according to claim 1, wherein the predesignated user comprises any one of the payer, the electronic commerce enterprise and a tax department.

11. The electronic invoice issuing system according to claim 1, comprising a plurality of security electronic invoice apparatuses.
